(19) United States
(12) Patent Application Publication
(10) Pub. No.: US 2006/0224490 A1
(43) Pub. Date: Oct. 5, 2006

(54) Services scheduling

(76) Inventors: Shashi Seth, Foster City, CA (US); Sergio Monsalve, Los Altos, CA (US); David Feller, Los Altos Hills, CA (US); Robert Dean Veres, Evanston, IL (US); Erik Rannala, San Francisco, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/095,934

(22) Filed: Mar. 31, 2005

(51) Int. Cl. G06Q 40/00

(52) U.S. Cl. 705/37

(57) ABSTRACT

A system and a method to receive a price submission in connection with a service at an incremental time block is described. Schedule information is to be received from a service provider. The information indicates at least one incremental time block at which the service provider is available to provide the service. The schedule information is to be published to a service consumer. A price submission in connection with at least one incremental time block is to be received from the service consumer.

### FIELD

The disclosed subject matter relates generally to the technical field of services scheduling.

### BACKGROUND

Consumers often make increasing efforts to maximize their time efficiency, while service providers often make increasing efforts to maximize their profits. Accordingly, a service provider often attempts to make any transaction as quick and convenient as possible.

However, convenience is not possible for all parties in many transactions, for example, when the service provider is providing services to one consumer, while a second consumer is attempting to book a service. Often, at least one consumer waits to be assisted. If the waiting time is too long, the consumer may try a different service provider, and the original service provider may have lost business.

In order to prevent business loss, much time may be spent by service providers in connection with booking services. Often, additional personnel may be hired to handle booking services so that the service provider may concentrate on providing the service to other consumers. Especially for small businesses, additional personnel may be cost prohibitive.

Further, if the service provider has unexpected availability, e.g. a “last-minute” appointment cancellation, the associated time block may be difficult for the service provider to fill, and lost profits may result.

### SUMMARY

According to one embodiment, a system and a method are described. A system and a method to receive a price submission in connection with a service during a time block are described. Schedule information is to be received from a service provider. The schedule information indicates at least one time block at which the service provider is available to provide the service. The schedule information is to be published to a service consumer. A price submission in connection with the at least one time block is to be received from the service consumer.

Other features will be apparent from the accompanying drawings and from the detailed description that follows.

### BRIEF DESCRIPTION OF THE DRAWINGS

Embodiments of the present invention are illustrated by way of example and not limitation in the Figures of the accompanying drawings, in which like references indicate similar elements and in which:

FIG. 1 illustrates a diagram depicting a system, according to an example embodiment of the present invention, having a client-server architecture.

FIG. 2 illustrates a high-level entity-relationship diagram, illustrating various tables that may be maintained within databases, according to an example embodiment.

FIG. 3 illustrates a listing interface according to an example embodiment.

FIG. 4 illustrates a search interface according to an example embodiment.

FIG. 5 illustrates a listing interface according to an example embodiment.

FIG. 6 illustrates a flow chart of a method, according to an example embodiment of the present invention.

FIG. 7 illustrates a flow chart of a method, according to an example embodiment of the present invention.

FIG. 8 illustrates a network diagram depicting a system, according to an example embodiment of the present invention, having a client-server architecture.

FIG. 9 illustrates a block diagram showing an application server that is part of the network-based system in another example embodiment of the present invention.

FIG. 10 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

According to one embodiment, a system and a method are described. A system and a method to receive a price submission in connection with a service during a time block are described. Services and schedule information is to be received from a service provider. The services and schedule information may be received from the service provider(s) through an interface similar to the listing interface of eBay Inc., of San Jose, Calif., see for example, http://sell.ebay.com/sell?ssPageNane=h:h:sYi:US. Information related to advertising the service, including a format, a service category, schedule information (including availability and corresponding prices), a title & description, a picture and/or details may be received from the service provider and displayed or published to the service consumer. The schedule information may be downloaded to the system and linked and/or synchronized with the time management program of the service provider. The schedule information indicates at least one time block at which the service provider is available to provide the service.

In the following description, for purposes of explanation, numerous specific details are set forth in order to provide a thorough understanding of embodiments of the present invention. It will be evident, however, to one skilled in the art that embodiments of the present invention may be practiced without these specific details.

Platform Architecture

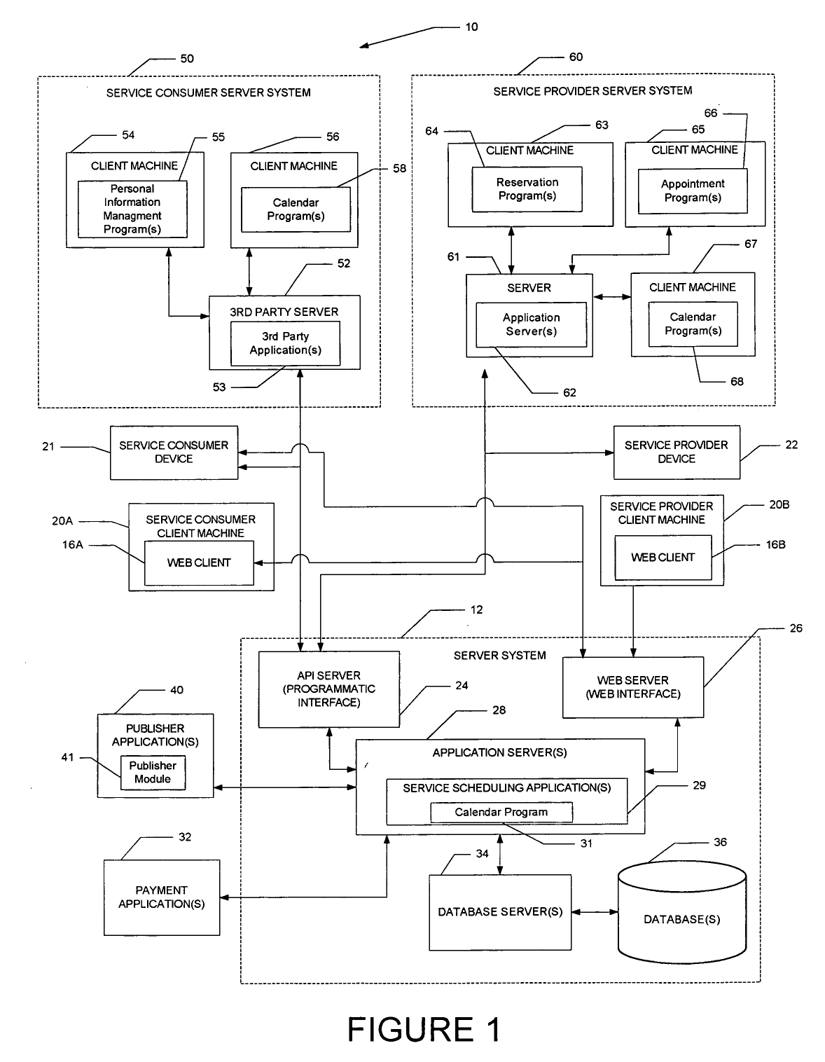

FIG. 1 illustrates a diagram depicting a system 10 having a client-server architecture, according to an example embodiment of the present invention. A server system 12 provides server-side functionality to one or more clients, wherein clients may include one or more service consumers and/or one or more service providers.

Turning specifically to the server system 12, an Application Program Interface (API) server 24 and a web server 26 are coupled to, and provide programmatic and web interfaces respectively to, one or more application servers 28. The application server(s) 28 may host one or more service scheduling application(s) 29, as described in more detail herein. The one or more service scheduling application(s) 29 may provide a calendar program 31, as described in more detail herein. The application server(s) 28 are, in turn, shown to be coupled to one or more database servers 34 that facilitate access to one or more databases 36.

The application server(s) of the server system 12 may be coupled to one or more payment application(s) 32 and one or more publisher application(s) 40. The payment application(s) 32 may provide a number of payment services and functions to users. The payment application(s) 32 may effect a payment from a selected service consumer to a selected service provider. The payment application(s) 32 may allow users to accumulate value (e.g., in a commercial currency, such as the U.S. dollar, or a proprietary currency, such as “points”) in accounts, and then later to redeem the accumulated value for a product and/or a service.

The publisher application 40 may include a publisher module 41. The publisher module 41 may publish schedule information of one or more service providers to one or more service consumers. The schedule information may indicate at least one time interval, time period, time slot, and/or incremental time block at which at least one service providers are available to provide a service, as described in more detail below. Incremental time blocks may increase one time block to the next time block gradually by regular, consecutive additions. For example, a gradual increase may be every 5 minutes, every 15 minutes, every 30 minutes, every hour, etc. depending on the service that the service provider provides. The schedule information may include a listing of at least one incremental time block, and may include a listing of a plurality of incremental time blocks.

Further, while the system 10 shown in FIG. 1 employs a client-server architecture, embodiments are of course not limited to such an architecture, and could equally well find applications in a distributed, or peer-to-peer, architecture system. The payment application(s) 32 may be implemented as standalone software programs, which do not necessarily have networking capabilities.

FIG. 1 further illustrates, for example, a web client 16A, 16B (e.g., a browser, such as the Internet Explorer browser developed by Microsoft Corporation of Redmond, Wash. State) executing on respective client machines 20A, 20B, e.g. on a network-based device. The web client(s) 16A, 16B executing on the device(s) 20A, 20B may access the application server(s) 28 via the web interface supported by the web server 26.

A service consumer device(s) 21 and a service provider device 22 may couple with the system 12. The device(s) 21, 22 may each include one or more of a mobile device, a palmtop computer, a laptop computer, a desktop computer, a personal digital assistant, a cellular telephone, a communications device, a wireless telephone, a land-line telephone, a control system, a camera, a scanner, a telephone with a web browser, a facsimile machine, a printer, a pager, and/or a personal trusted device. The device(s) may include a card, such as a smart card, a magnetic card, and/or a key card. The device(s) may include a telephone or any device capable of Short Messaging Service (SMS) messaging, multimedia messaging service (MMS) messaging and/or generating audio tones, such as dual-tone multi-frequency (DTMF) tones. The device(s) may engage in an interactive message and/or open communication session, such as SMS, electronic mail, Wireless Application Protocol (WAP), web, interactive voice response (IVR) and/or other mobile interfaces. The device(s) may be browser-enabled. A hyperlinked URL may be delivered directly to the device and may be used to access a web site or a WAP site directly. The device(s) may enable mobile videophone communications, digital television signals, and/or digital radio signals. The scanner device(s) may include a bar code reader/scanner, a Radio Frequency Interface System (RFIS) reader, and/or a symbol reader/scanner. The device(s) 21, 22 may receive a confirmation of a booking associated with providing the service to the service consumer, as described herein. The device may include a time management program that is synchronized with an interface that accepts bookings in accordance with embodiments herein. For example, when the service consumer makes a reservation, the time management program automatically blocks out that time interval.

FIG. 1 further illustrates, for example, a service consumer server system 50 and a service provider server system 60. The service consumer server system 50 may include a third party server 52 having one or more third party application(s) 53. The third party application 53 may have programmatic access to the server system 12 via the programmatic interface provided by the API server 24. The third party application 53 may, utilizing information retrieved from the server system 12, support one or more features or functions on a website hosted by the third party. The third party website may, for example, provide one or more promotional, commerce or payment functions that are supported by the relevant applications of the server system 12. The third party website may display an interface similar to the interfaces described herein.

The third party server 52 may be coupled to client machines 54, 56 of the service consumer. The service consumer server system 50 may include the client machine 54 having one or more personal information management (PIM) program(s) 55. The PIM program(s) may include, for example, Microsoft's® Outlook®. The service consumer server system 50 may also include the client machine 56 having one or more calendar program(s) 58. The calendar program 58 may, for example, manage time availability of the service consumer. The calendar program(s) 58 may be coupled to the calendar program(s) 31 of the service scheduling application(s) 29. The calendar program may be synchronized with the calendar program 31 of the application server(s) 28.

The programmatic client(s) 55, 58 executing on the machines 54, 56, respectively, may access the application server(s) 28 via the programmatic interface provided by the API server 24. The programmatic interface may receive from the service consumer, a price submission in connection with the at least one incremental time block of the schedule information, which may indicate when one or more service providers are available to provide the service. Additionally or alternatively, the price submission may be provided to the publisher module 41 through one or more web clients 16A. The calendar program 58 may also be associated with a calendar program accessible through the web client 16A and/or a third party website. The web client(s) 16A may access the application server(s) 28 and/or the publisher application(s) 40 via the web interface provided by the web server 26.

The service provider server system 60 may include a server 61 having one or more application server(s) 62. The server 61 may have programmatic access to the server system 12 via the programmatic interface provided by the API server 24. The server 61 may, utilizing information retrieved from the server system 12, support one or more features or functions on a website hosted by the server. The server website may, for example, provide one or more promotional, commerce or payment functions that are supported by the relevant applications of the server system 12. The website may display an interface similar to the interfaces described herein.

The server 61 may be coupled to client machines 63, 65, 67 of the service provider. The service provider server system 60 may include the client machine 63 having one or more reservation program(s) 64. The service provider server system 60 may include the client machine 65 having one or more appointment program(s) 66. The service provider server system 60 may also include the client machine 67 having one or more calendar program(s) 68. The schedule information may be provided to the publisher module 41 through the one or more of the reservation program(s) 64, the one or more appointment program(s) 66, and/or the one or more calendar program(s) 68.

The calendar program 68 may, for example, manage time availability of the service provider. The calendar program(s) 68 may be coupled to the calendar program(s) 31 of the service scheduling application(s) 29. The calendar program may be synchronized with the calendar program 31 of the application server(s) 28.

The programmatic client(s) of the service provider server system 60 may, for example, be a seller application (e.g., the TurboLister application developed by eBay Inc., of San Jose, Calif.) to enable sellers to author and manage products on the system 12 in an off-line manner, and to perform batch-mode communications between the programmatic client and the server system 12.

The programmatic client(s) 64, 66, 68 executing on the machines 63, 65, 67, respectively, may access the application server(s) 28 and/or the publisher application(s) 40 via the programmatic interface provided by the API server 24. The programmatic interface of the API server 24 may receive the schedule information from the one or more service providers.

Additionally or alternatively, the schedule information may be provided to the publisher module 41 through one or more web clients 16B. The calendar program 68 may also be associated with a calendar program accessible through the web client 16B and/or a third party website. The web client(s) 16B may access the application server(s) 28 and/or the publisher application(s) 40 via the web interface provided by the web server 26.

Data Structures

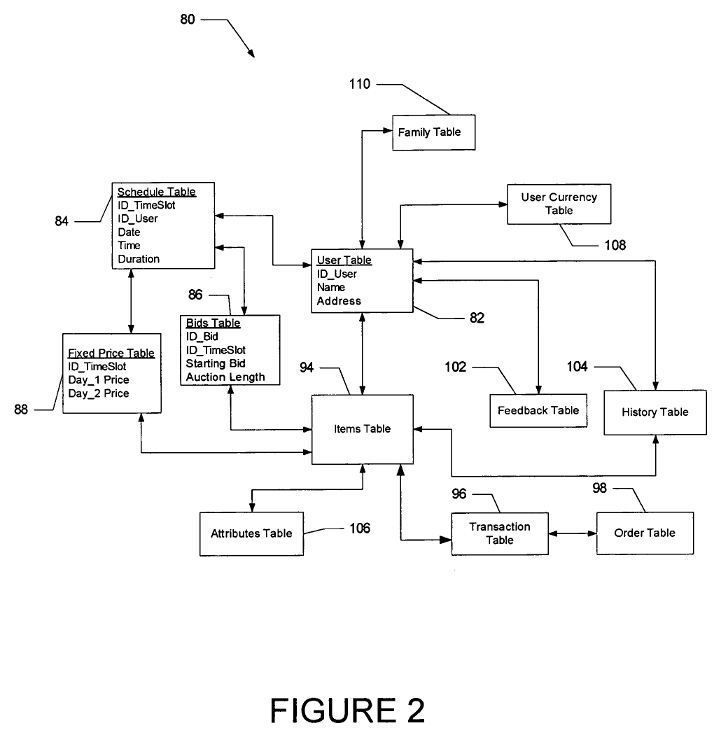

FIG. 2 illustrates a high-level entity-relationship diagram, illustrating various tables 80 that may be maintained within the databases 36 according to an example embodiment. The tables 80 may be utilized by and support the application server(s) 28, including the service scheduling application(s) 29.

The tables 80 may include a user table 82. The user table 82 contains a record for each registered user of the server system 12, and may include user identification, address (including default address) and financial instrument information pertaining to each such registered user. A user may, it will be appreciated, operate as a seller, a buyer, or both, within the server system 12. In an example embodiment of the present invention, a buyer may be a user that has accumulated value (e.g., commercial or proprietary currency in the system account), and is then able to exchange the accumulated value for products that are offered for sale by the commerce application 30. The user table 82 may be accessible by the database server(s) 34.

The tables 80 may include a schedule table 84. The schedule table 84 may include an identification of a time slot associated with a service, a user identification of the service provider from the user table 82, a date of the time slot, a time of the time slot, and a duration of the time slot. Other data may be included in the schedule table as appropriate. Each record within the schedule table(s) 84 may furthermore be linked to one or more user records within the user table 82.

The tables 80 may include a bids table 86. The bids table 86 may include an identification of the bid, an identification of the time slot from the schedule table 84, a starting bid, and an auction length. Other data may be included in the bids table as appropriate. Bid records within the bids table each relate to a bid received at the server system 12 in connection with an auction-format product supported by auction application(s) 44 discussed herein. Each record within the bids table(s) 86 may furthermore be linked to one or more schedule records within the schedule table 84.

The tables 80 may include a fixed-price table 88. The fixed-price table 88 may include an identification of the time slot from the schedule table 84, and one or more prices associated with a time period, e.g. day 1 price and day 2 price. Other data may be included in the bids table as appropriate. Each record within the fixed-price table 88 may furthermore be linked to one or more schedule records within the schedule table 84.

The tables 80 may also include an items table 94 in which are maintained item (or product) records for goods, donations, and services that are available to be, or have been, transacted via the system 12. Each item record within the items table 94 may furthermore be linked to one or more user records within the user table 82, so as to associate a seller and one or more actual or potential buyers with each item record. Additionally, each item record within the items table 94 may furthermore be linked to one or more bids records within the bids table 86, and/or linked to one or more fixed-price records within the fixed-price table 88.

The tables 80 may include a transaction table 96. The transaction table 96 contains a record for each transaction (e.g., a purchase transaction) pertaining to products for which records exist within the items table 94.

The tables 80 may include an order table 98. The order table 98 is populated with order records, each order record being associated with an order. Each order, in turn, may be with respect to one or more transactions for which records exist within the transactions table 96.

The tables 80 may include a feedback table 102. The feedback table 102 is utilized by one or more reputation applications 52, in an example embodiment, to construct and maintain reputation information concerning users.

The tables 80 may include a history table 104. The history table 104 maintains a history of transactions to which a user has been a party.

The tables 80 may include one or more attributes tables 106. The attributes tables 106 record attribute information pertaining to products for which records exist within the items table 94. Considering a single example of such an attribute, the attributes tables 106 may indicate a currency attribute associated with a particular product. The currency attribute may identify the currency of a price for the relevant product as specified by a seller. A family table 110 and user-currency table 108 may be used to support related products and multiple currencies in transactions.

Interfaces

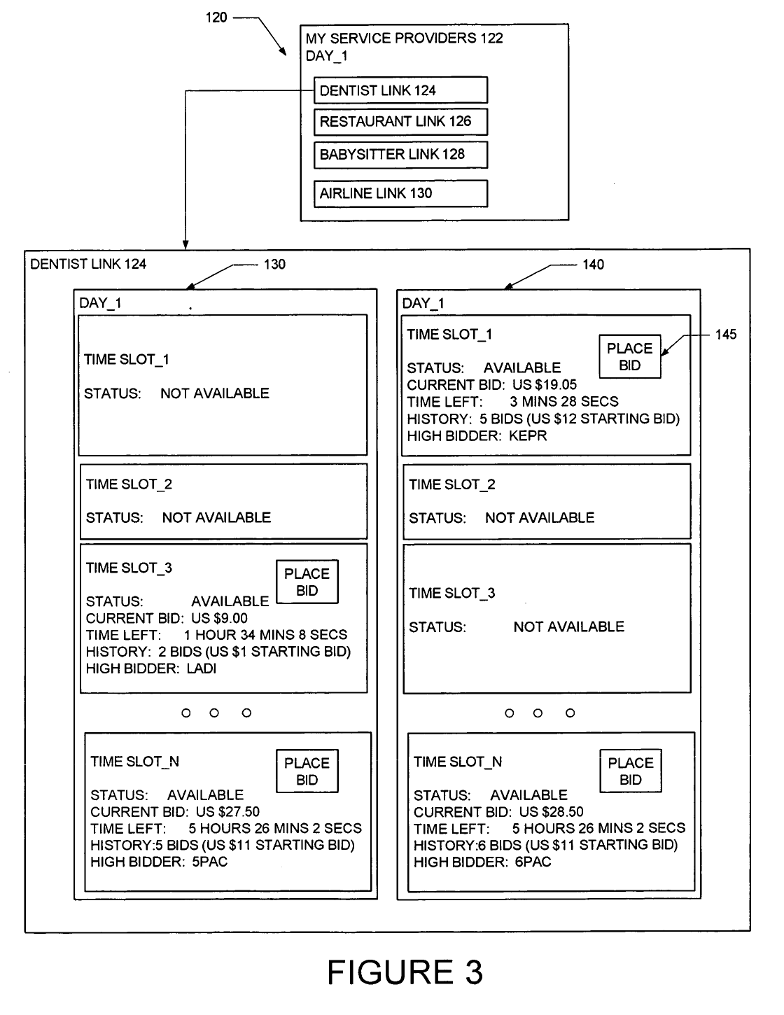

FIG. 3 illustrates a listing interface 120 according to an example embodiment. The listing interface 120 may include a list of “My Service Providers.” The interface 120 may be accessible through the web client 16A, the third party application(s) 53, the PIM program(s) 55, and/or the calendar program 58. The interface 120 may be published on the publisher application(s) 40.

In this example listing for a particular day, Day_{—}1, links to a plurality of service providers are listed. The service providers listed may have been pre-selected by the service consumer. The list may include a dentist link 124, a restaurant link 126, a babysitter link 128, and an airline link 130. Upon activating the respective link, the schedule information associated with that service provider may be displayed or published. The published schedule information may be associated with the publisher module 41, and the information may have been generated using the service scheduling application(s) 29.

In the illustrated example, the dentist link 124 is activated to publish the schedule of the selected dentist on Day_{—}1. For Day_{—}1 in this example, the dentist has more than one set of time slots (e.g. more than one dental assistant and/or hygienist), a first set 130 and a second set 140. The Time Slot_1 of the first set 130 is indicated as not available. However, the Time Slot_1 of the second set 140 is indicated as available. The service consumer may indicate a desire to place a bid by activating an appropriate bid indicator 145. As shown, any relevant bid information may be displayed adjacent the appropriate time slot. The service consumer may scroll through the listing to find the time and/or the price that suits their availability. There may also be a link to other days on which the dentist may be available.

The types of services and service providers that may be a part of this system may include any service provider that may use a schedule, a calendar, reservations, and appointments. The service may also be associated with a resource, such as renting or borrowing a resource. The resource may be a library book, real property, trucks, or equipment, for instance. The service appointments that may be made during available time blocks in the schedule information may include a restaurant reservation, a taxi reservation, a medical appointment, a dental appointment, an appointment with a utility provider, such as phone service, cable service, gas/electricity/DSL/satellite service, a babysitting service, a beautician appointment, a plumber appointment, an electrician appointment, a handy man appointment, a contractor appointment, professional services appointment, a tee time, or other recreational activities appointments, and any other service-related appointments and/or reservations. Embodiments contemplate small and/or local businesses, contractors and/or individuals to be service providers to the consumers. However, embodiments also contemplate including ticket reservations, airline reservations, hotel reservations, car rentals and other travel-related bookings.

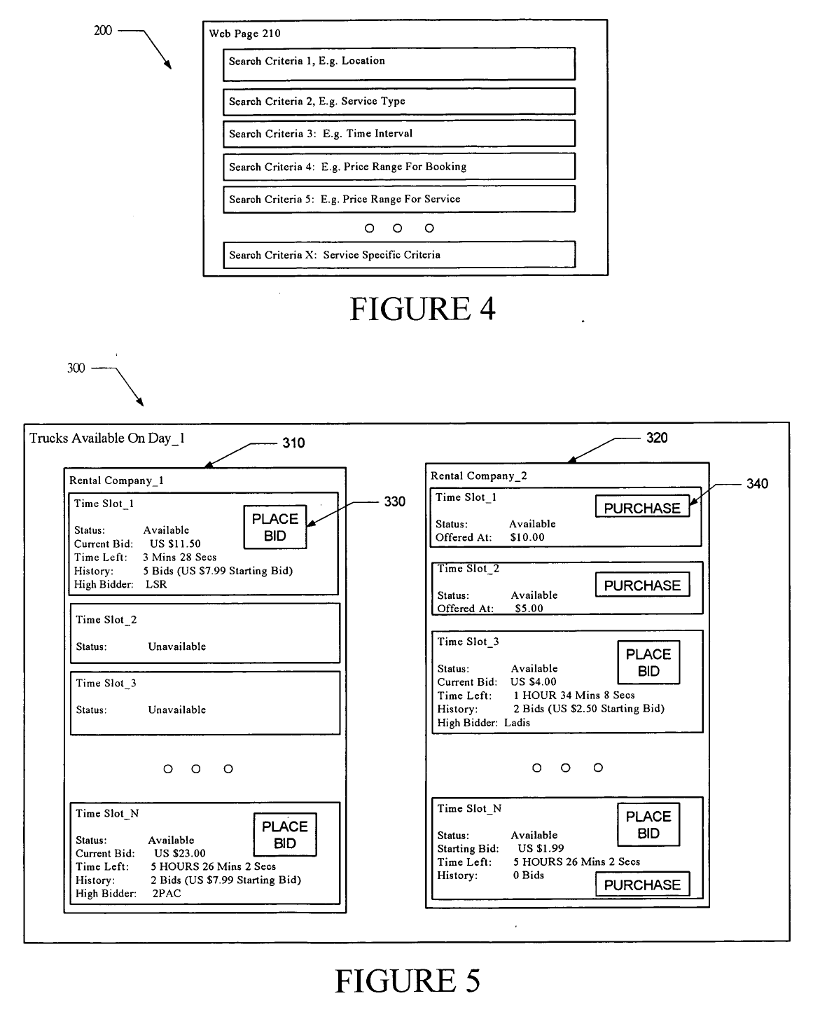

FIG. 4 illustrates a search interface 200 according to an example embodiment. The search interface 200 may include a web page 210 having a list of search criteria. The search criteria may include one or more of the following: a location of the service provider (e.g. within 5 miles of consumer's zip code), a service type (e.g. truck rental services), an incremental time block (e.g. 9:00 am to 10:00 am, or anytime between 9:00 am and 4:00 pm), a price range related to booking the service, a price range related to providing the service, any service specific criteria (e.g. insurance provider of the service consumer), and any other criteria specified by the consumer. The search interface 200 receives search criteria from the service consumer to search for at least one service provider to provide the specified service.

FIG. 5 illustrates a listing interface 300 according to an example embodiment. The listing interface 300 may include the results of the search executed using the search criteria specified in the interface shown in FIG. 4. The listing interface 300 may publish each service provider that meets the criteria. The listing interface 300 may be associated with the publisher module 41, and the results may have been generated using the service scheduling application(s) 29.

For Day_{—}1 in this example, there is more than one service provider having available time slots and/or available incremental time blocks. In the example shown, a first service provider 310 and a second service provider 320 that meet the criteria selected by the consumer is published in the interface 300. Time slots selected that fall within the time block search criteria that are available for bid and/or purchase may be listed. Unavailable time slots selected in the search criteria may also be listed.

The service provider 310 indicates in this example that Time Slot_1 is available. The service provider 320 indicates in this example that Time Slot_1 is also available. The service consumer may indicate a desire to place a bid for a time slot by activating an appropriate bid indicator 330. Additionally and/or alternatively, the service consumer may indicate a desire to purchase a time slot by activating an appropriate fixed-price indicator 340. As shown, any relevant bid or price information may be displayed adjacent the appropriate time slot. The service consumer may scroll through the listing to find the time and/or the price that suits their availability. There may also be a link to other days or times that the rental company may have available trucks, for example.

A price submission in connection with the at least one time block is to be received from the service consumer. The price submission, including the bidding price and/or fixed-price offer, may include a booking fee associated with booking the service provider during the selected time block. Additionally or alternatively, the price submission, including the bidding price and/or fixed-price offer, may include the cost associated with the service.

The fixed-price offer and/or the starting bid associated with the service may vary with respect to time. In an embodiment, the starting bid (or offer price) is greater for a first time block as compared to a second later time block. This higher starting bid (or offer price), shown for example at second set 140 of FIG. 3, may be used in the instance where it is anticipated that many consumers are interested in initializing phone service, for example, as soon as possible. In an additional embodiment, the starting bid (or offer price) is less for a first time block as compared to a second later time block. This lower starting bid (or offer price), shown for example at first set 130 of FIG. 3, may be used in the instance where the dentist had a last-minute cancellation, for example.

In an instance where many consumers may use the service offered by the service provider, the consumers may pool their bids to submit one larger bid to the service provider for the service.

Flowcharts

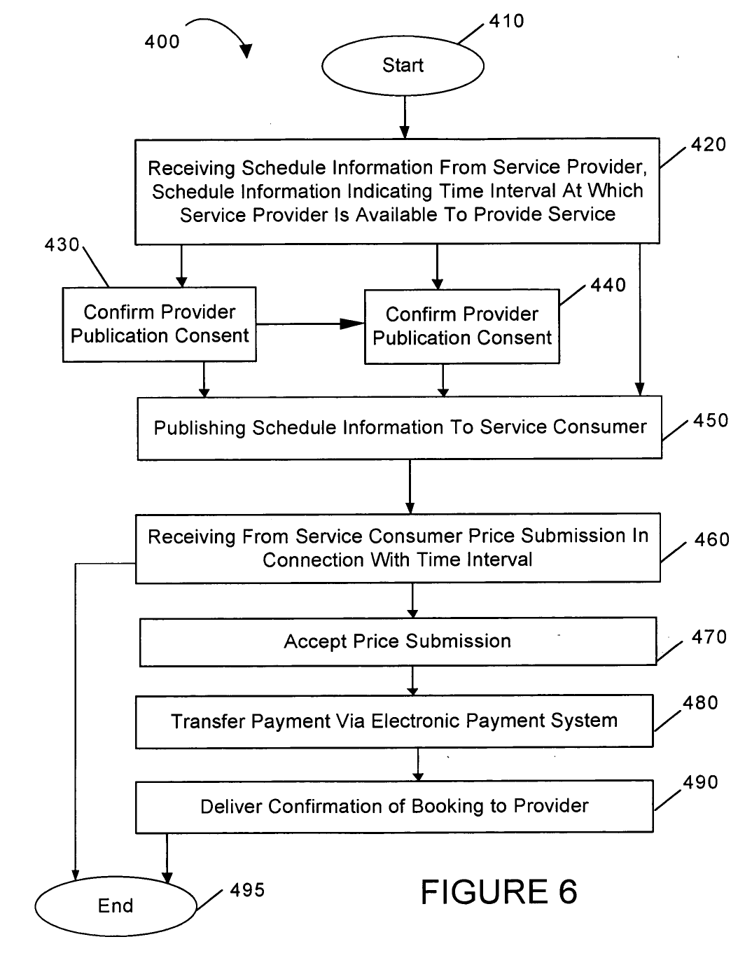

FIG. 6 illustrates a flow chart of a method 400, according to an example embodiment of the present invention.

The method 400 may begin at block 410.

At block 420, schedule information may be received from the service provider. The schedule information may indicate the time block during which the service provider may be available to provide the service to a consumer. Block 420 may proceed to either block 430, 440 or 450, depending upon the application.

At block 430, service provider consent to publication in the listing to one or more consumers may be confirmed. Block 430 may proceed to either block 440 or block 450, depending upon the application.

At block 440, the method confirms that the service provider consents to publication in the listing. The method proceeds to block 450.

At block 450, the schedule information is published to the consumer.

At block 460, a price submission in connection with the time block is received from the service consumer. The price submission may be a bid or an acceptance of a fixed-price offer. The method 400 may proceed to block 470 or block 495, depending upon the application.

At block 470, the price submission is accepted.

At block 480, the electronic payment system 32 transfers payment from the consumer to the provider.

At block 490, confirmation of the booking is delivered to the provider and/or the consumer. The confirmation may be delivered via the device 22, 21, respectively.

At block 495, the method 400 ends.

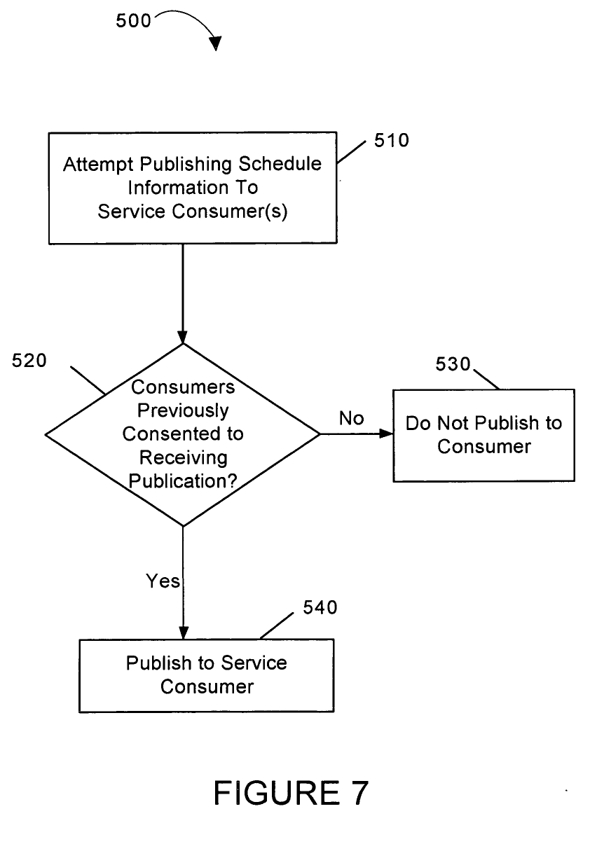

FIG. 7 illustrates a flow chart of a method 500, according to an example embodiment of the present invention. The method 500 may describe in more detail the block 450 of FIG. 6.

At block 510, publishing schedule information to one or more service consumers may be attempted.

At block 520, the method 500 queries whether the consumers consented to receiving the published schedule information of service providers. In an embodiment, this consent may be a previously selected consent. If the answer to the query is no, the method 500 proceeds to block 530. If the answer to the query is yes, the method 500 proceeds to block 540.

At block 530, the schedule information is not published to the consumer.

At block 540, the schedule information is published to the consumer.

Another Platform Architecture

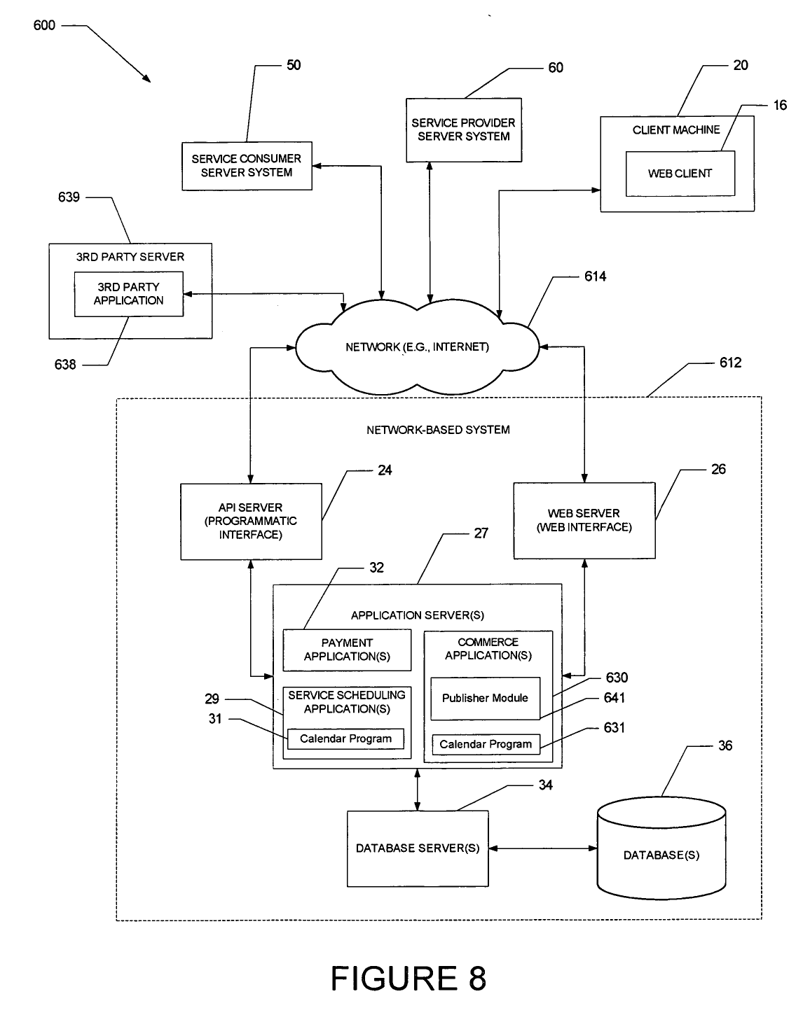

FIG. 8 illustrates a network diagram depicting a system 600, according to an example embodiment of the present invention, having a client-server architecture. The system 600 may be similar to the system 10 of FIG. 1, however, differences may be discussed herein.

A system, in the example form of a network-based system 612, provides server-side functionality, via a network 614 (e.g., the Internet, a public or private switched telephone network (wireline or wireless), a private wireless network using technologies such as Bluetooth or IEEE 802.11x or other networks) to one or more clients.

In this embodiment, both commerce application(s) 30 and the payment application(s) 32 may be part of the application server(s) 27 of the network-based system 612. The application server(s) 27 may host one or more service scheduling application(s) 29, one or more commerce application(s) 630 and one or more payment application(s) 32.

The commerce application(s) 630 may include the publisher module 641, which may be similar to the publisher module 41.

The calendar program(s) 31 of the service scheduling application(s) 29 may be coupled with, and/or may be synchronized with one or more calendar programs 631 of the commerce application(s) 630. The calendar program(s) 631 may manage a time frame associated with selling on the network-based commerce system and/or buying on the network-based commerce system.

FIG. 8 may also illustrate a third party application 638, executing on a third party server machine 639, as having programmatic access to the network-based system 612 via the programmatic interface provided by the API server 24. For example, the third party application 638 may, utilizing information retrieved from the network-based system 612, support one or more features or functions on a website hosted by the third party. The third party website may, for example, provide one or more promotional, marketplace or payment functions that are supported by the relevant applications of the network-based system 612.

Application Server(s)

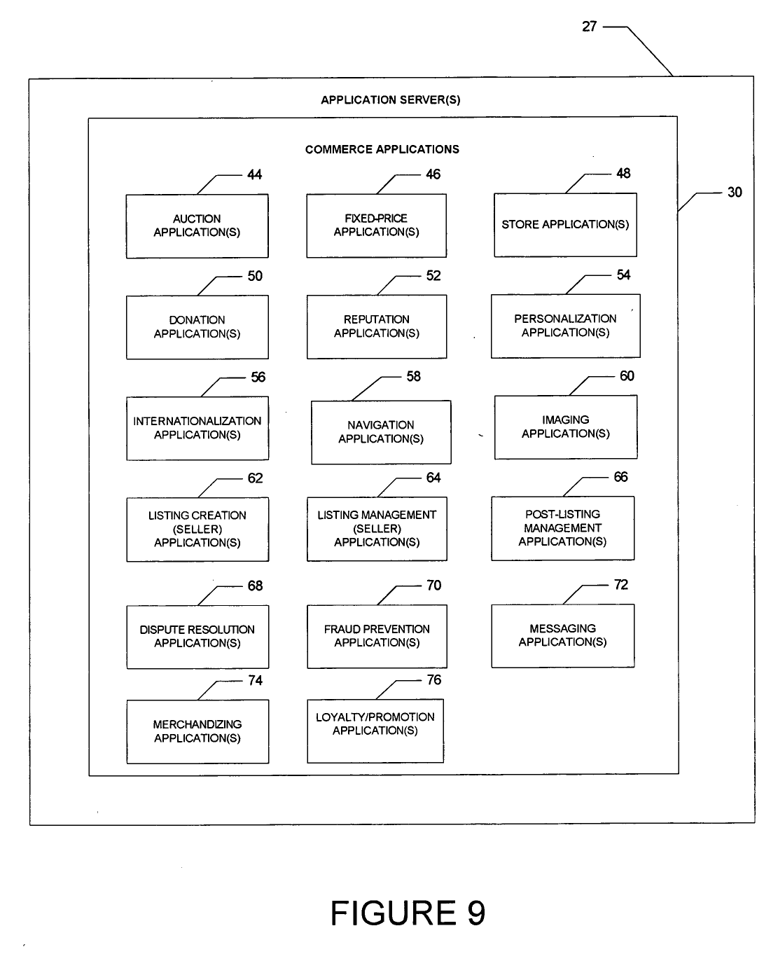

FIG. 9 illustrates a block diagram showing an application server 27 that is part of the network-based system 612 in another example embodiment of the present invention. The commerce application(s) 30 may provide a number of marketplace functions and services to users that access the system 612. The commerce applications 30 may provide a number of product and price-setting mechanisms whereby a seller may list goods or services for sale or a donation request, a buyer can express interest in or indicate a desire to purchase such goods or services or to donate, and a price can be set for a transaction pertaining to the goods or services, or donation.

The commerce applications 30 may include one or more auction applications 44 that support auction-format product and price setting mechanisms (e.g., English, Dutch, Vickrey, Chinese, Double, Reverse auctions, etc.). The various auction applications 44 may also provide a number of features in support of such auction-format products, such as a starting bid feature and/or a reserve price feature whereby a seller may specify a reserve price in connection with a product and a proxy-bidding feature whereby a bidder may invoke automated proxy bidding.

The commerce applications 30 may include one or more fixed-price application(s) 46. The fixed-price applications 46 support fixed-price product formats and buyout-type products. The fixed-price product format may include, for example, the traditional classified advertisement-type product, a catalogue product, a television advertisement product, a magazine product, a billboard product, a banner ad product, or any other type of virtual or physical marketplace medium. In an embodiment, buyout-type products (e.g., including the Buy-It-Now (BIN) technology developed by eBay Inc., of San Jose, Calif.) may be offered in conjunction with an auction-format product, and allow a buyer to purchase goods or services or make a donation, which are also being offered for sale via an auction, for a fixed-price that may be higher than the starting price of the auction.

The commerce applications 30 may include one or more store applications 48. In an embodiment, the store applications 48 allow sellers to group their products within a physical store or even a “virtual” store, which may be branded and otherwise personalized by and for the sellers. Such a store may also offer promotions, incentives and features that are specific and personalized to a relevant seller.

The commerce applications 30 may include one or more donation applications 50 that support the product listing associated with a charitable institution and/or a specific charitable event. The listing format may include any type of marketplace medium, e.g. virtual or physical, and may include recommended donation amount(s) and/or may ask for a user-defined amount to be donated.

The commerce applications 30 may include one or more reputation applications 52. The reputation applications 52 allow parties that transact utilizing the network-based system 612 to establish, build, and maintain reputations, which may be made available and published to potential trading partners. Consider that where, for example, the network-based system 612 supports person-to-person trading, users may have no history or other reference information whereby the trustworthiness and credibility of potential trading partners may be assessed. The reputation applications 52 allow a user, for example through feedback provided by other transaction partners, to establish a reputation within the network-based system 612 over time. Other potential trading partners may then reference such a reputation for the purposes of assessing credibility and trustworthiness.

The commerce applications 30 may include one or more personalization applications 54. The personalization applications 54 allow users of the system 612 to personalize various aspects of their interactions with the system 612. For example a user may, utilizing an appropriate personalization application 54, create a personalized reference page at which information regarding transactions to which the user is (or has been) a party may be viewed. Further, a personalization application 54 may enable a user to personalize products and other aspects of their interactions with the system 612 and other parties.

The commerce applications 30 may include one or more internationalization applications 56. In one embodiment, the network-based system 612 may support a number of marketplaces that are customized, for example, for specific geographic regions. A version of the system 612 may be customized for the United Kingdom, whereas another version of the system 612 may be customized for the United States. Each of these versions may operate as an independent marketplace, or may be customized (or internationalized) presentations of a common underlying marketplace.

Navigation of the network-based system 612 may be facilitated by one or more navigation applications 58. For example, a search application enables key word searches of products published via the system 612. A browse application allows users to browse various category, catalogue, or inventory data structures according to which products may be classified within the system 612. Various other navigation applications may be provided to supplement the search and browsing applications.

In order to publish listings and/or products, available via the network-based system 612, as visually informing and attractive as possible, the commerce applications 30 may include one or more imaging applications 60. Users may upload images for inclusion within listings. An imaging application 60 also operates to incorporate images within viewed listings. The imaging applications 60 may also support one or more promotional features, such as image galleries that are presented to potential buyers. For example, sellers may pay an additional fee to have an image included within a gallery of images for promoted items.

The commerce applications 30 may include one or more product creation applications 62. The product creation applications 62 allow sellers conveniently to author products pertaining to goods or services that they wish to transact via the system 612. Product management applications 64 allow sellers to manage such goods or services products. Specifically, where a particular seller has authored and/or published a large number of products, the management of such products may present a challenge. The product management applications 64 provide a number of features (e.g., auto-reproduct, inventory level monitors, etc.) to assist the seller in managing such products. One or more post-product management applications 66 also assist sellers with a number of activities that typically occur post-product. For example, upon completion of an auction facilitated by one or more auction applications 44, a seller may wish to leave feedback regarding a particular buyer. To this end, a post-product management application 66 may provide an interface to one or more reputation applications 52, so as to allow the seller conveniently to provide feedback regarding multiple buyers to the reputation applications 52.

The commerce applications 30 may include dispute resolution applications 68. The dispute resolution applications 68 provide mechanisms whereby disputes arising between transacting parties may be resolved. For example, the dispute resolution applications 68 may provide guided procedures whereby the parties are guided through a number of steps in an attempt to settle a dispute. In the event that the dispute cannot be settled via the guided procedures, the dispute may be escalated to a mediator or arbitrator.

The commerce applications 30 may include fraud prevention applications 70. A number of fraud prevention applications 70 implement various fraud detection and prevention mechanisms to reduce the occurrence of fraud within the system 612. The fraud prevention application may prevent fraud in user identification associated with the device and/or in identifier submission.

The commerce applications 30 may include messaging applications 72. The messaging applications 72 are responsible for the generation and delivery of messages to users of the network-based system 612. Such messages, for example, advise users regarding the status of products at the system 612 (e.g., providing “outbid” notices to bidders during an auction process or to provide promotional and merchandising information to users).

The commerce applications 30 may include merchandising applications 74. The merchandising applications 74 support various merchandising functions that are made available to sellers to enable sellers to increase sales via the system 612. The merchandising applications 74 also operate the various merchandising features that may be invoked by sellers, and may monitor and track the success of merchandising strategies employed by sellers.

The network-based system 612 itself, or one or more parties that transact via the system 612, may operate loyalty programs that are supported by one or more loyalty/promotions applications 76. For example, a buyer may earn loyalty or promotions points for each transaction established and/or concluded with a particular seller, and may be offered a reward for which accumulated loyalty points can be redeemed.

Computer System

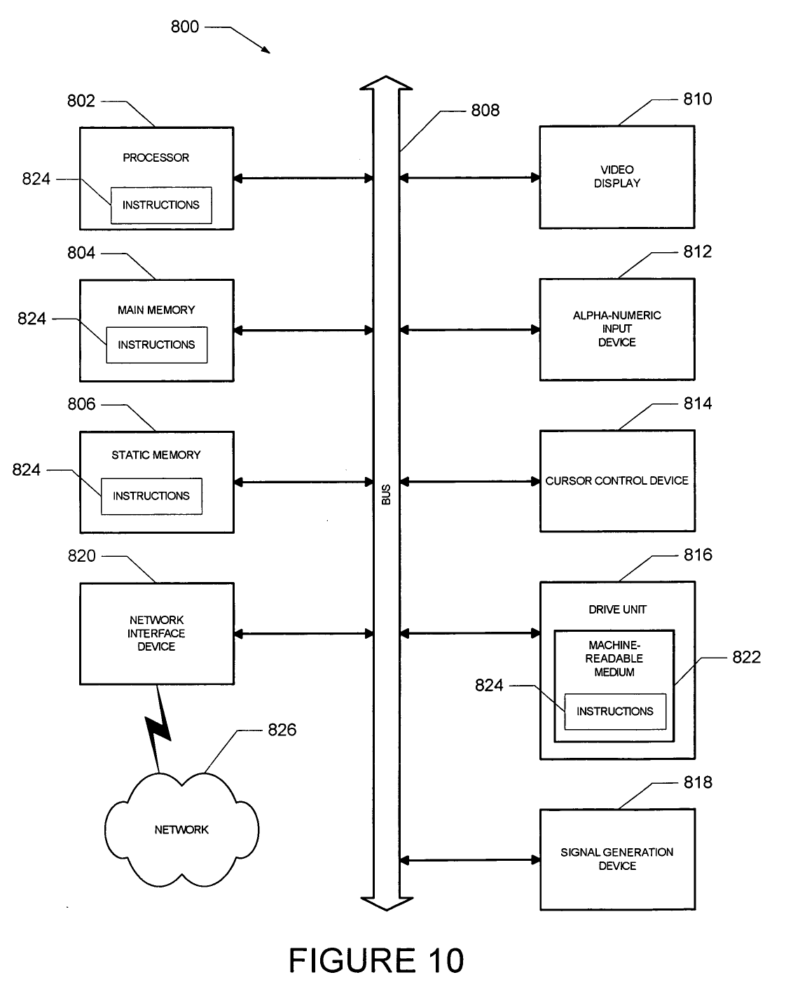

FIG. 10 shows a diagrammatic representation of a machine in the example form of a computer system 800 within which a set of instructions, for causing the machine to perform any one or more of the methodologies discussed herein, may be executed. In alternative embodiments, the machine operates as a standalone device or may be connected (e.g., network) to other machines. In a network deployment, the machine may operate in the capacity of a server or a client user machine in server-client user network environment, or as a peer machine in a peer-to-peer (or distributed) network environment. The machine may be a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

Further, while a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies or functions described herein. The instructions 824 may also reside, completely or at least partially, within the main memory 804, the static memory 806, and/or within the processor 802 during execution thereof by the computer system 800. The main memory 804 and the processor 802 also may constitute machine-readable media.

The instructions 824 may further be transmitted or received over a network 826 via the network interface device 820.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. FIGS. 1 to 10 are merely representational and may not be drawn to scale. Certain proportions thereof may be exaggerated, while others may be minimized. Accordingly, the specification and drawings are to be regarded in an illustrative rather than a restrictive sense.

The following description includes terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

Thus, embodiments describe a method and a system to receive a price submission in connection with a service during a time block. Although embodiments of the present invention have been described with reference to specific example embodiments, it will be evident that various modifications and changes may be made to these embodiments without departing from the broader spirit and scope of embodiments as expressed in the subjoined claims.

What is claimed is:

1. A system comprising:
a publisher module to publish schedule information to a service consumer, the schedule information having a listing of at least one time block at which a service provider is available to provide a service; and
an interface to receive the schedule information from the service provider, and to receive from the service consumer a price submission in connection with the at least one time block.

2. The system of claim 1 wherein the service includes rental service of a resource during the at least one time block, and the price submission is to rent the resource.

3. The system of claim 1 wherein the price submission is selected from a group including a cost associated with booking the service provider during the at least one time block and a cost associated with the service.

4. The system of claim 1 wherein the interface is selected from a group including a web interface and an application programmatic interface.

5. The system of claim 1 further comprising a network-based commerce application including the publisher module to publish the schedule information.

6. The system of claim 1 further comprising an electronic payment system to effect a payment from the service consumer to the service provider.

7. The system of claim 1 wherein the publisher module is to publish the schedule information to a set of service consumers.

8. The system of claim 7 wherein the set of service consumers previously consent to the publication.

9. The system of claim 1 wherein the price submission includes one of a bid and an acceptance of an offer associated with a fixed price.

10. The system of claim 9 wherein the fixed price includes time-variable prices.

11. The system of claim 1 wherein there are a plurality of available slots associated with the service provider during the at least one time block.

12. The system of claim 1
wherein the interface further is to receive the schedule information from a plurality of service providers and includes a searching interface to receive search criteria from the service consumer to search for at least one service provider of the plurality of service providers to provide the service.

13. The system of claim 12 wherein the interface includes a listing to publish the at least one service provider that meets the search criteria.

14. The system of claim 13 wherein the at least one service provider previously consents to publication in the listing.

15. A system comprising:
a publisher module to publish schedule information to a service consumer, the schedule information to indicate at least one time block at which a service provider is available to provide a service; and
an interface to receive the schedule information from the service provider, and to receive from the service consumer a bid in connection with the at least one time block.

16. The system of claim 15 wherein the bid is selected from a group including a cost associated with booking the service provider during the at least one time block and a cost associated with the service.

17. The system of claim 15 wherein the bid includes a starting bid associated with the service, wherein the starting bid is greater for a first time block of the at least one time block as compared to a second later time block of the at least one time block.

18. The system of claim 15 wherein the price submission includes a starting bid associated with the service, wherein the starting bid is less for a first time block of the at least one time block as compared to a second later time block of the at least one time block.

19. The system of claim 15 wherein there are a plurality of available slots associated with the service provider during the at least one time block.

20. The system of claim 19 wherein the interface receives the bid from a plurality of service consumers.

21. The system of claim 15 further comprising a calendar program to manage time availability of at least one of a group including the service consumer and the service provider.

22. The system of claim 21 further comprising a network-based commerce system including the publisher module to publish the schedule information, wherein the calendar program is to manage a time frame associated with at least one of a group including selling on the network-based commerce system and buying on the network-based commerce system.

23. The system of claim 21 wherein the calendar program is in sync with a calendar program associated with a party, wherein the party is selected from a third party and the service provider.

24. The system of claim 15 further comprising a device to receive confirmation of a booking associated with providing the service to the service consumer.

25. The system of claim 15 wherein the schedule information is selected from a group including a reservation and an appointment.

26. A method comprising:
receiving schedule information from a service provider, the schedule information indicating at least one time block at which the service provider is available to provide a service;
publishing the schedule information to a service consumer; and
receiving from the service consumer a bid in connection with the at least one time block.

27. The method of claim 26 wherein the service includes rental service of a resource during the at least one time block, and the bid is to rent the resource.

28. The method of claim 26 wherein the bid is selected from a group including a cost associated with booking the service provider during the at least one time block and a cost associated with the service.

29. The method of claim 26 further comprising searching for at least one service provider to provide the service using search criteria received from the service consumer.

30. A machine-readable medium storing a sequence of instructions that, when executed by a computer, cause the computer to perform the method of claim 26.

31. A method comprising:
receiving schedule information from a plurality of service providers, the schedule information indicating at least one time block at which the plurality of service providers are available to provide a service;
publishing the schedule information to a service consumer; and
receiving from the service consumer a price submission in connection with the at least one time block.

32. The method of claim 31 wherein the price submission includes one of a bid and an acceptance of an offer associated with a fixed price.

33. The method of claim 32 further comprising varying the fixed price associated with the service based on time.

34. The method of claim 31 further comprising synchronizing a first calendar program with a second calendar program associated with a party, wherein the party is selected from at least one of the plurality of service providers and a third party, wherein the first calendar program is to manage time availability of at least one of a group including the service consumer and at least one of the plurality of service providers, wherein the first calendar program is to manage a time frame associated with at least one of a group including selling on a network-based commerce system and buying on the network-based commerce system.

35. A machine-readable medium storing a sequence of instructions that, when executed by a computer, cause the computer to perform the method of claim 26.

36. A system comprising:
means for publishing schedule information to a service consumer, the schedule information indicating at least one incremental time block at which a service provider is available to provide a service; and
means for receiving schedule information from a service provider and for receiving from the service consumer a bid in connection with the at least one incremental time block.

37. The system of claim 36 wherein the means for receiving the schedule information includes an interface.

38. The system of claim 36 wherein the means for publishing includes a publisher module of a network-based commerce system.
